(19) United States
(12) Patent Application Publication
(10) Pub. No.: US 2006/0289076 A1
(43) Pub. Date: Dec. 28, 2006

(54) Method of charging low temperature liquified gas

(75) Inventors: Hyang Ja Jang, Ulsan (KR); Yuichi Iikubo, West Lafayette, IN (US); Dae Hyun Kim, Ulsan (KR); Cheol Ho Kim, Ulsan (KR)

Correspondence Address: John S. Egbert;Egbert Law Offices, 7th Floor, 412 Main Street, Houston, TX, 77002, US

(73) Assignee: ULSAN CHEMICAL Co., Ltd., Ulsan (KR)

(21) Appl. No.: 11/404,596

(22) Filed: Apr. 17, 2006

(30) Foreign Application Priority Data
Jun. 27, 2005 (KR) 10-2005-0055635

(51) Int. Cl. B65B 31/00; F17C 13/00

(52) U.S. Cl. 141/4; 62/50.7

(57) ABSTRACT

Disclosed is a method of charging a low temperature liquefied gas in a gaseous state in a high pressure charging cylinder using a pump. The method is advantageous in that it is possible to charge a low temperature liquefied gas which is to be made highly pure in a high pressure gas cylinder using a simple process in which purity is not changed and little energy is consumed during the charging of the liquefied gas.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a method of charging a low temperature liquefied gas, which is present in a gaseous phase at normal temperature, in a gaseous phase in a high pressure charging cylinder. More particularly, the present invention pertains to a method of charging a low temperature liquefied gas, in which the low temperature liquefied gas is compressed to a desired pressure in a liquid state using a pump and the compressed liquid is charged in a gaseous phase in a high pressure gas cylinder.

### BACKGROUND OF THE INVENTION

Therefore, the development of a method of storing NF₃, wh Generally, liquefied gas having a low boiling point is present in a liquid state at a critical low temperature or less, but is present in a gaseous state above the critical temperature. In the present invention, this gas is called a low temperature liquefied gas. Due to the above characteristics, the liquefied gas is charged in a gaseous state at a pressure of several tens −200 kg/cm²G in a high pres sure cylinder. The liquefied gas is exemplified by nitrogen, oxygen, and argon, which are extensively used for general purposes, and nitrogen trifluoride (NF₃, boiling point: −129° C.), sulfur hexafluoride (SF₆), anhydrous hydrochloric acid (AHCl), anhydrous hydrogen bromide (AHBr), carbon tetrafluoride (CF₄), and hexafluoroethane (C₂F₆), which are used in the semiconductor industry.

A conventional method of charging liquefied gas comprises condensing it at low temperatures during production, storing it in a liquid state in a storage container, passing it through a vaporizer or a heat exchanger to vaporize it, and charging the vaporized gas in a high pressure gas cylinder while it is compressed using a compressor.

The reason why the method, in which the liquefied gas is vaporized and the vaporized gas is charged in the cylinder while it is compressed using the compressor, is frequently adopted when the low temperature liquefied gas is charged in the cylinder as described above is as follows. If a pump is applied to a low temperature liquid having a low boiling point, cavitation (a phenomenon in which desirable operation of a pump becomes impossible when a liquid having a low boiling point is vaporized and then charged in a pump head) occurs, making normal operation of the pump impossible. However, in the case of the compressor for compressing the vaporized gas, it is not necessary to worry about cavitation.

However, the method is problematic in that the temperature of the charged gas rises due to the heat of compression generated when the gas is compressed using the compressor, and, in serious cases with respect to this, a product is decomposed, and thus, impurities are increased, thereby reducing purity. Other problems are that the maintenance cost is high due to the abrasion of parts and a charging speed is reduced at a high pressure. However, there is no clear solution plan due to the characteristics of the compressor, but complementary measures, such as the mitigation of problems caused by heat of compression through cooling of gas using a cooler provided on a compressor head or a discharge part and the removal of impure particles using a filter mounted on the discharge part, are conducted. Nevertheless, essential problems have not been avoided.

Moreover, in accordance with advances in the semiconductor industry, demand for gas of higher purity used in the same field is growing, and the criterion for impurity content of the gas is becoming increasingly strict.

In the conventional method, in which the liquefied gas is vaporized and the vaporized gas is charged in the container while it is compressed using the compressor, energy consumption is high during the vaporization and compression processes, and, in the case of gas which is to be made highly pure, such as nitrogen trifluoride (NF₃) gas used as an etching gas in a process of fabricating semiconductors, there is the undesirable high possibility of deterioration of the gas.

Accordingly, in the above field, there remains a need to develop a method of charging a liquefied gas, in which energy consumption is reduced and deterioration of the gas is avoided during a charging process.

### BRIEF SUMMARY OF THE INVENTION

The present invention relates to a method in which a low temperature liquefied gas is compressed in a liquid state using a pump and the compressed liquid is charged in a high pressure gas cylinder after passing through a vaporizer, or is directly charged in the cylinder.

The present inventors have found that, unlike a conventional method, in which gas is charged in a gaseous state in a high pressure gas cylinder using a compressor, when liquefied gas, such as NF₃, which is to be highly pure, is charged in a high pressure gas cylinder using a pump under a condition which does not cause cavitation, deterioration does not occur during the charging process and the charging is achieved using little energy, thereby accomplishing the present invention.

An object of the present invention is to provide a novel charging technology in which a low temperature liquefied gas is charged using a pump, thus problems of heat generation caused during a compression process using a compressor, of high energy cost, and of vibration and noise are pre-emptively prevented. The technology is economical and stable and therefore useful for general purposes and for the charging of ultra-highly pure semiconductor gas, such as NF₃.

### BRIEF DESCRIPTION OF THE SEVERAL VIEWS OF THE DRAWINGS

The above and other objects, features and advantages of the present invention will be more clearly understood from the following detailed description taken in conjunction with the accompanying drawings.

FIG. 1 is a schematic view illustrating a process of charging a liquefied gas in a cylinder using a pump of the present invention.

FIG. 2 is a schematic view illustrating a process of charging a liquefied gas in a cylinder using a conventional vaporizer and compressor.

### DETAILED DESCRIPTION OF THE INVENTION

In a method of charging liquefied gas using the pump, the liquefied gas can be easily compressed to a desired pressure not in a gaseous state but in a liquid state using the pump during a compression process, and it is possible to conduct transportation at an almost constant flow rate at low and high pressures, thus a charging time can be reduced. Additionally, since heat generation is very small at a high compression ratio, it is possible to safely charge a material, such as NF3, which has significantly increased reactivity and significantly decomposes at high temperatures. Furthermore, since liquid (low temperature liquefied gas) is charged in a head part of the pump, lubrication is assured, thus the formation of metal particles due to friction or abrasion is prevented. Additionally, In comparison with a compressor, since it has a small size and requires little power, it is possible to minimize power, operation, and maintenance costs, and desirable operational efficiency is assured because the charging time is shortened.

Since the compressor transports gas after compressing it but the pump directly transports liquid, the size of the compressor must be 10 times that of the pump or more if the same amount of liquefied gas is to be charged.

The pump is used to transport and charge liquid, and typically comprises a head including a piston and a check valve, a motor providing power, and a mechanical operation part (a gear and an operating part of the piston) which generates fluid pressure using the rotational strength of the motor.

In the present invention, it is preferable that a pipe be connected from a storage container, in which the low temperature liquefied gas is stored in a liquid state, to a suction part of the pump, and that a suction pipe be completely insulated or cooled using a low temperature refrigerant so as to prevent cavitation caused by vaporization of a low temperature liquid.

It is preferable that the head part of the pump be completely insulated to prevent cavitation and, if necessary, a cooling coil or a double jacket capable of being cooled using a low temperature refrigerant be provided thereon. A pipe which is connected to a storage tank is connected to a discharge pipe of the pump so that pump priming and a residual solution in the discharge pipe are recycled into the storage tank. During a pump priming process, the liquid circulates from the storage tank through the above pipe, and, after the charging is finished, the residual solution and the pressure in the discharge pipe are recycled into the storage tank therethrough to minimize the loss of products.

Furthermore, a manometer is provided to check the operation of the pump and a discharge pressure, and a safety device is provided against overpressure. It must be noticed that, if the low temperature liquefied gas is completely charged in the pipe and the pipe is airtightly closed, overpressure may occur due to expansion caused by an increase in temperature, and in serious cases, the pipe may be damaged. The liquefied gas which is compressed by the pump is transported through the pipe connected to charging devices to a charging container, and it may be directly charged or may be charged after it has been vaporized at normal temperature using a separate vaporizer or heat exchanger provided on the discharge pipe. If it is directly charged in the container, a valve of the container is closed after the charging is finished and the container is left at normal temperature to vaporize the charged liquid. A charging amount is measured using a balance, and a manometer is provided on a charging device to check the charging pressure so as to prevent excessive charging. The charging method of the present invention can be applied to both of a single charging device and a plurality of charging devices.

A better understanding of the present invention may be obtained through the following example and comparative example which are set forth to illustrate, but are not to be construed as the limit of the present invention.

### EXAMPLE

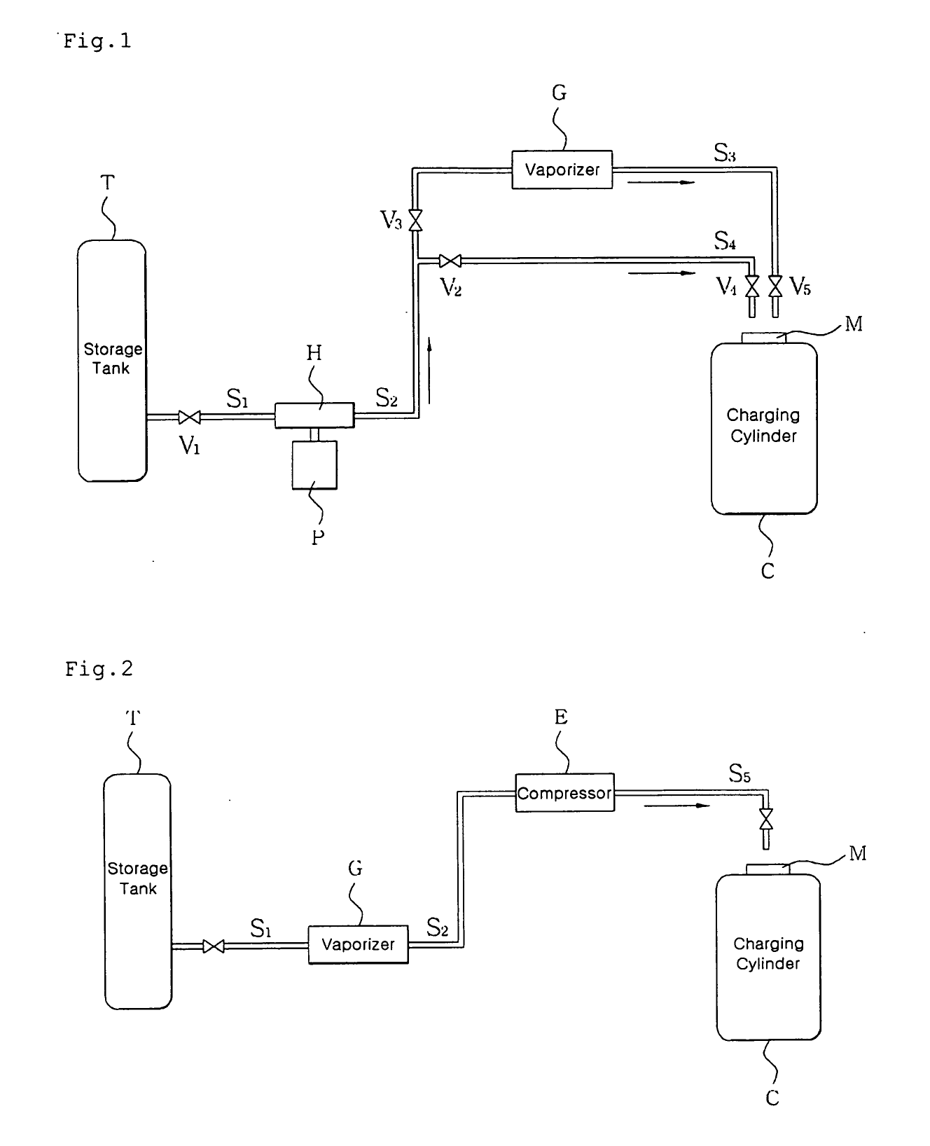

A detailed description will be given of a charging method according to the present invention, referring to FIG. 1. Highly pure NF₃ liquid which was condensed at low temperatures was used as a liquefied gas for a charging test. A storage tank (T) was connected to a process for producing NF₃ through a pipe, and a double vacuum jacket was provided on an external surface of the storage tank (T) to insulate it. NF₃ liquid stored in the storage tank was transported through a suction pipe into a suction part of a pump, and the suction pipe (S₁) into a suction part of a pump, and the suction pipe (S₁) was made of a double pipe type of vacuum insulating pipe. A manometer was provided at a discharge part of the pump to check normal operation of the pump. The charging container was connected to a discharge pipe (S₂) of the pump and the charging container was provided on a balance to check a charging amount. The charging was conducted through the following procedure. A low temperature piston pump was used as the pump of the present example.

A charging pipe (S₄) and a high pressure cylinder (G) were connected to each other, and valves (V₁, V₂) were closed and valves (V₃, V₄, V₅) were opened to create a vacuum of 1 Torr or less so as to remove air and moisture from the pipe. Before this, moisture was removed from the high pressure cylinder (G), and the high pressure cylinder (G) was vacuumized to prepare for charging.

2) After the procedure of 1) was finished, the valves (V₃, V₄, V₅) were closed and the valves (V₁, V₂) were opened to conduct pump priming, and the pump was then operated to conduct circulation.

3) When the temperature of the pump head was low enough to transport liquid well and pressure was rapidly increased if the valve (V₂) was closed, the valves (V₃, V₄) were opened to charge NF₃ liquid in the charging cylinder.

4) After the charging was finished, the valve (V₄) was closed, the pump was stopped, and the valves (V₁, V₂, V₃) were opened to recycle the remaining solution from a charging pipe (S₄) into the storage tank and make pressure uniform therein. All of the valves were closed and the charging cylinder was separated. The charging cylinder was left at normal temperature in order to increase the temperature to normal temperature.

Alternatively, the liquefied gas which was compressed using the pump (P) and transported through the discharge pipe (S₂) was passed through the vaporizer (G) to be vaporized and then charged in a gaseous phase through a charge pipe (S₃) in the cylinder (C).

### Comparative Example

A detailed description will be given of a conventional process of charging a liquefied gas in a cylinder using a vaporizer and a compressor, referring to FIG. 2. NF₃ liquid which was condensed at low temperatures was used as a liquefied gas for a charging test. A storage tank (T) was connected to a process for producing NF₃ through a pipe, and a vacuum jacket was provided on an external surface of the storage tank (T) to insulate it. The NF₃ liquid stored in the storage tank was transported through a suction pipe (S₁) into a vaporizer. The NF₃ liquid passing through the vaporizer including a heater therein was easily vaporized due to an increased temperature to form a gaseous phase. The NF₃ gas which was supplied into the compressor through a discharge pipe (S₂) was compressed, and the compressed NF₃ gas was charged through a discharge pipe (S₅) in a charging cylinder (C).

The gas that was charged in a liquid state in the charging cylinder using the pump (P) in the Example and the gas that was charged in a gaseous state in the charging cylinder using the vaporizer (G) and the compressor (E) In the Comparative Example were measured to determine purity and acidity. The measured values were compared to the purity and acidity of NF₃ in the storage tank (T), and the results are described in the following Table 1.

TABLE 1

| | Purity | HF | HNO₃ | |
|---|---|---|---|---|
| Classification | (%) | (ppm) | (ppm) | Fine particles (Ea/L) |
| Storage tank | 99.998 | 0.015 | 0.150 | 1.9 × 10⁻³ |
| Comparative example | 99.997 | 0.026 | 0.653 | 7.7 × 10⁻² |
| Example | 99.998 | 0.017 | 0.251 | 1.7 × 10⁻² |

In the Comparative example, the purity is insignificantly changed, but the acidity is significantly increased. The reason seems to be that the gas was activated due to the heat of compression of the compressor, thus NF₃ gas is easily decomposed.

As well, the number of fine particles is increased. This seems to be caused by mechanical friction during compression charging using the compressor.

However, in the Example, changes in purity and acidity were insignificant.

In the above Table 1, impurities were analyzed using gas chromatography and the results were collected to measure the purity of gas. As for acidity analysis, after a predetermined amount of product gas was absorbed onto water, neutralization titration was conducted using NaOH to measure the total acidity. The amount of HNO₃ was calculated by subtracting the amount of HF from the total acidity. The amount of HF was obtained using an F ion analyzer, and the existence of HNO₃ was confirmed through an anion qualitative analysis using sulfuric acid and FeSO₄. The fine particles were measured using a particle measuring device, and only the particles having a size of 0.2 μm or less were considered.

The method of the present invention is advantageous in that it is possible to charge a low temperature liquefied gas which is to be highly pure in a high pressure gas cylinder using a simple process in which the liquefied gas does not deteriorate and little energy is consumed.

Although the preferred embodiment of the present invention has been disclosed for illustrative purposes, those skilled In the art will appreciate that various modifications, additions and substitutions are possible, without departing from the scope and spirit of the invention as disclosed in the accompanying claims.

We claim:

1. A method comprising the steps of:
charging a low temperature liquefied gas in a high pressure charging cylinder using a pump, wherein an insulating pipe is used as a pipe for transporting the low temperature liquefied gas therethrough.

2. The method as set forth in claim 1, wherein said low temperature liquefied gas is selected from a group consisting of:
nitrogen trifluoride, nitrogen, oxygen, argon, sulfur hexafluoride, anhydrous hydrochloric acid, anhydrous hydrobromic acid, carbon tetrafluoride, and hexafluoroethane.

3. The method as set forth in claim 1, wherein the cylinder has a liquid compressed using the pump directly charged therein, or charged in a gaseous phase in the cylinder after the liquid is vaporized by an evaporator or a vaporizer provided on a discharge part of the pump.
